(19) United States
(12) Patent Application Publication
(10) Pub. No.: US 2008/0088527 A1
(43) Pub. Date: Apr. 17, 2008

(54) Heads Up Display System

(76) Inventors: Keitaro Fujimori, Nagano-ken (JP); John Peter van Baarsen, Delta (CA); Doug McFadyen, Delta (CA); Tatiana Pavlovna Kadantseva, Vancouver (CA); Takashi Shindo, Chino-shi (JP); Kevin Gillett, South Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/550,389

(22) Filed: Oct. 17, 2006

(51) Int. Cl. G09G 5/00

(52) U.S. Cl. 345/7

(57) ABSTRACT

A vehicle having a heads up display (HUD) system is provided. The HUD system includes an image rendering device configured to provide a distorted representation of image data to a non-planar surface within a field of view of an occupant of the vehicle. Warp image circuitry configured to store offsets to be applied to the image data to generate the distorted representation provided to the image rendering device is included in the HUD system. The offsets represent respective distances for moving coordinates of a portion of pixels within the image data and the offsets are stored within a memory region of the warp image circuitry. The portion of pixels correspond to vertices of polygons. The offsets are derived through calibration data provided to the warp image circuitry. The calibration data is selected from one of a plurality of view positions for the occupant.

### CROSS REFERENCE TO RELATED APPLICATIONS

This Application is related to application Ser. No. 11/550,180 (Atty Docket No. VP247) entitled “Calibration Technique for Heads Up Display System,” application Ser. No. 11/550,153 (Atty Docket No. VP248) entitled “Method and Apparatus for Rendering an Image Impinging Upon a Non-Planar Surface,” and application Ser. No. ______ (Atty Docket No. VP251) entitled “Warp Image Circuit.” These applications are herein incorporated by reference in their entireties for all purposes.

### BACKGROUND

In an attempt to enhance safety features for automobiles, heads up displays (HUD) are being offered as an option for purchasers of some automobile models. The virtual image is projected from the instrument panel onto the windshield. As windshields are not flat or perpendicular to the driver's eyes, the image must be corrected to ensure that it is undistorted and easy to read. In some solutions the use of a special wedge shaped intermediate layer is used to change the geometry of the glass and provide the optical correction needed for image reflection. In other solutions, an optical lens is manually adjusted by a technician during the manufacturing of the automobile to alter the image being projected so that the perceived image is undistorted.

However, all of the current solutions lack the ability to adjust to any changes of the projector, observer viewpoint, or changes to the windshield. Thus, when something changes after being originally set-up, the owner of the vehicle must take the vehicle in to have the system re-adjusted to accommodate the change. These limitations make the currently available HUD systems inflexible and costly.

As a result, there is a need to solve the problems of the prior art to provide a HUD system that can be adjusted in a cost efficient manner in order to gain widespread acceptance with consumers.

### SUMMARY

Broadly speaking, the present invention fills these needs by providing a digital solution for a Heads Up Display that is flexible. It should be appreciated that the present invention can be implemented in numerous ways, including as a process, an apparatus, a system, a device, or a method. Several inventive embodiments of the present invention are described below.

In one embodiment, a vehicle having a heads up display (HUD) system is provided. The HUD system includes an image rendering device configured to provide a distorted representation of image data to a non-planar surface within a field of view of an occupant of the vehicle. Warp image circuitry configured to store offsets to be applied to the image data to generate the distorted representation provided to the image rendering device is included in the HUD system. The offsets represent respective distances for moving coordinates of a portion of pixels within the image data and the offsets are stored within a memory region of the warp image circuitry. The portion of pixels correspond to vertices of polygons. The offsets are derived through calibration data provided to the warp image circuitry. The calibration data is selected from one of a plurality of view positions for the occupant.

In another embodiment, a heads up display (HUD) is provided. The HUD includes a memory storing offsets to be applied to image data to generate a distorted representation of the image data. The HUD further includes warp image logic configured to map the image data to a non-planar surface and calculate an amount of distortion introduced into polygon sections of the image data on the non-planar surface. The warp image logic is further configured to determine an inverse of the amount of distortion to be applied to the image data to attenuate the amount of distortion introduced by the non-planar surface. An image rendering device configured to direct the inverted and distorted representation of the image data to the non-planar surface is included in the HUD.

In yet another embodiment, a digitally based heads up display (HUD) system capable of presenting a non-distorted image off of a non-planar surface is provided. The digitally based HUD system includes a calibration module configured to generate a set of inputs for a de-warping process. The HUD system further includes warp image circuitry configured to execute the de-warping process. The warp image circuitry generates a set of offsets to be applied to a portion of image data, where the offsets are generated from the set of inputs of the calibration module. The warp image circuitry is further configured to determine an amount of distortion experienced by the image data from the non-planar surface to generate an inverse of the amount of distortion and apply the inverse of the amount of distortion to the image data. An image rendering device receiving the image data having the inverse amount of distortion applied thereto is included in the HUD system. The image rendering device directs the image data having the inverse amount of distortion to the non-planar surface where the inverse amount of distortion abrogates the distortion introduced by the non-planar surface so that the image data is perceived by a viewer as being non-distorted.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram illustrating a vehicle with a heads up display system in accordance with one embodiment of the invention.

FIG. 2 is a simplified schematic diagram of an overall system architecture incorporated into a vehicle, in which a heads up display system is integrated, in accordance with one embodiment of the invention.

FIG. 3 is a simplified schematic diagram further illustrating the functional blocks of the warp image circuitry in accordance with one embodiment of the invention.

FIG. 4A is a simplified schematic diagram illustrating an exemplary application the heads up display system for a vehicle in accordance with one embodiment of the invention.

FIG. 4B is a simplified schematic diagram illustrating an alternative embodiment to FIG. 4A.

FIG. 5 is a simplified schematic diagram of an alternative embodiment for a heads up display system in accordance with one embodiment of the invention.

### DETAILED DESCRIPTION

In the following description, numerous specific details are set forth in order to provide a thorough understanding of the present invention. However, it will be apparent to one skilled in the art that the present invention may be practiced without some of these specific details. In other instances, well known process operations and implementation details have not been described in detail in order to avoid unnecessarily obscuring the invention.

A Heads Up Display system is described below in more detail. The HUD system is a digital solution that provides flexibility at a relatively low cost. In order to produce a de-warped image on a warped surface, a one-time calibration process is performed in accordance with the embodiments described below. This calibration process is performed for each projection, surface, and observer view instance. That is, if the projector, or image generating device, is changed or moved, or if the surface is changed or moved, or if the observer's viewpoint is moved, a new calibration process is required. In one embodiment, data from a plurality of calibration processes may be saved. In this embodiment, the saved data may be accessed in response to a change occurring, e.g., for the projector, the observer's viewpoint, etc. Thus, rather than having to manually adjust an optical lens to accommodate a changed condition, the saved calibration data may be accessed to provide a digital solution in a much more efficient manner.

As a high-level overview of the calibration process, the following operations are performed: a calibration image is projected normally, onto the warped surface. The calibration image, as projected onto the warped surface, is digitally photographed from an observer's viewpoint. The data of the digital photograph is then analyzed and processed by software having the functionality described in more detail below. The results from the processing become input data for de-warping software, also referred to as inverse warping software, which intentionally manipulates the data based on the calibration results so that a projected image modified by the de-warping software will appear non-distorted, as viewed by an observer. It should be appreciated that the calibration functionality may be incorporated into the HUD system. Alternatively, a calibration module performing the calibration functionality may be a separate module from the HUD system. In this embodiment, the calibration may be performed as detailed in U.S. patent application Ser. No. 11/550,180 (Atty Docket No. VP247) and the data saved to memory associated with the HUD system. One skilled in the art will appreciate that the stand-alone calibration module may be any computing system having calibration logic therein to perform the functionality described herein.

The HUD system also includes logic to render an image that impinges upon a non-planar surface that features mapping the image as a plurality of spaced-apart planar cells to coordinates of the non-planar surface, with each of the cells including multiple pixels of the image. The distance between the cells is minimized while minimizing a distance of each of the plurality of cells with respect to the surface coordinates; and impinging the plurality of planar cells upon the non-planar surface. Thus, an image that undergoes distortion as a result of impinging upon a non-planar surface may be rendered while minimizing the distortion perceived by a viewer. The image may be rendered by projecting the same with an image rendering device so as to be rendered with minimal distortions upon the non-planar surface, or spaced-apart from the non-planar surface. When rendered spaced-apart from the non-planar surface, the rendering region may be disposed so as to be positioned between the non-planar surface and the image rendering device or positioned so as that there is non-planar surface between the image rendering device and the image rendered. As used herein, mapping includes associating pixels of the image with a plurality of polygons, each of which defines one of the plurality of spaced-apart cells and includes multiple vertices having an initial spatial relationship. The vertices are mapped to coordinates of the non-planar surface, producing mapped polygons. A matrix of distortion coefficients is generated from the vertices of the mapped polygons. The distortion coefficients define a relative spatial relationship among the pixels upon the non-planar surface. Produced from the distortion matrix is an inverse matrix having a plurality of inverting coefficients associated therewith. The image rendering device impinges pixels upon the non-planar surface with the relative spatial relationship among the pixels of each of the mapped polygons defined by the inverting coefficients, producing inverted polygons. In this manner, distortions introduced by the non-planar surface are substantially abrogated or attenuated by impinging the image mapped according to the inverted polygons upon the non-planar surface. Further details of the inverse-warping or de-warping aspects are provided in U.S. patent application Ser. No. 11/550,153 (Atty Docket No. VP248).

A warp image circuit included in the HUD system functions to carry out the inverse warping or de-warping described above. The warp image circuit may be incorporated into a Heads Up Display (HUD) for a vehicle. As mentioned herein, offset values stored within the warp image circuit are used to manipulate image data, e.g., change coordinates of a portion of the pixels of the image data, so that the image may be directed to a non-planar surface and still be viewed as non-distorted. It should be appreciated that while the embodiments described below reference a HUD for an automobile, this is not meant to be limiting. That is, the embodiments described herein may be incorporated into any vehicle, including sea based vehicles, such as boats, jet skis, etc., air based vehicles, such as planes, helicopters, etc., and land based vehicles, such as automobiles, motorcycles, etc., whether motor powered or not. In addition, the HUD system may be incorporated with a helmet or other head fixture, such as eye glasses.

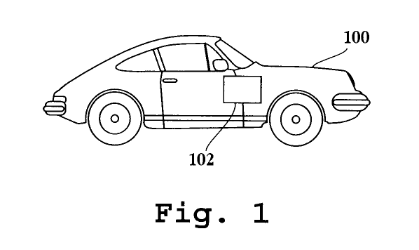

FIG. 1 is a simplified schematic diagram illustrating a vehicle with a heads up display system in accordance with one embodiment of the invention. Vehicle 100 includes heads up display module 102 therein. It should be appreciated that heads up display module 102 for the current embodiments is a digital system in which an image is digitally distorted and manipulated in order to abrogate or attenuate effects introduced due to being impinged on a non-planar surface. In this manner, the distortions introduced by the non-planar surface are negated so that a driver, or any other occupant, of a vehicle having the HUD system views a non-distorted image. One skilled in the art will appreciate that while an automobile is illustrated in FIG. 1, the invention is not limited to an automobile as any vehicle, whether powered by a motor or not, may utilize the embodiments described herein. In addition, the embodiments described herein may be extended to non-vehicle components, such as helmets, eyeglasses, etc.

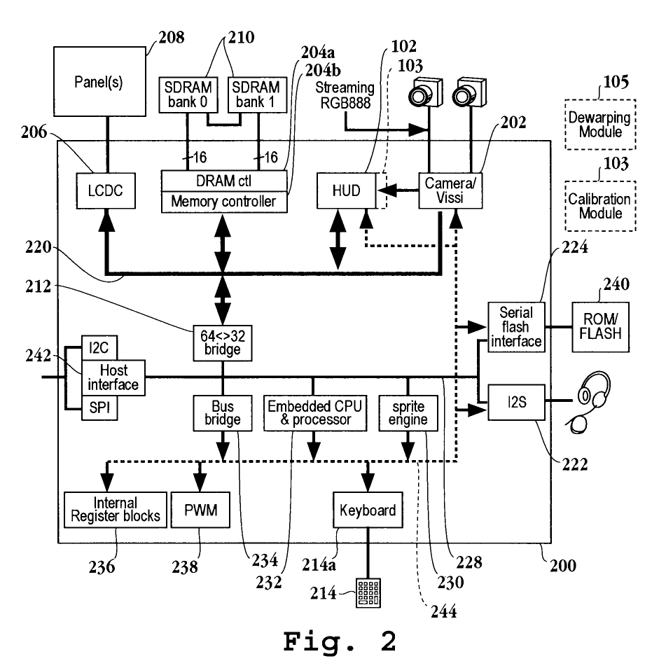

FIG. 2 is a simplified schematic diagram of an overall system architecture incorporated into a vehicle, in which a heads up display system is integrated, in accordance with one embodiment of the invention. System 200 includes heads up display module 102 and camera module 202. As discussed above, heads up display module 102 may include a camera or projector, alternatively, camera 202 may be a separate and distinct module from heads up display 102 as illustrated. Also included in system 200 is DRAM controller 204a and memory controller 204b for SDRAM modules 210. Within system 200 is liquid crystal display controller (LCDC) 206, which is in communication with display panel 208. One exemplary application for LCDC 206 and display panel 208 is a navigation system and display panel. For example, system 200 may be able to communicate with a subscription based communication, monitoring, and tracking service, such as the ONSTAR™ system. Memory controllers 204a and 204b, LCDC 206, HUD module 102 and camera module 202 are in communication over bus 220. Further included within system 200 is Inter-IC Sound (I2S) module 222 and serial flash interface 224. One skilled in the art will appreciate that I2S module 222 is a serial bus (path) design for digital audio devices and technologies such as compact disc players, digital sound processors, and digital TV sound. The I2S design handles audio data separately from clock signals. By separating the data and clock signals, time-related errors that cause jitter do not occur, thereby eliminating the need for anti-jitter devices. An I2S bus design typically consists of three serial bus lines: a line with two time-division multiplexing data channels, a word select line, and a clock line.

Continuing with FIG. 2, bridge 212 and bridge 234 function to provide communication between buses 220, 228 and 244. Sprite engine 230, embedded CPU and coprocessors 232, and host interface 242 are further illustrated within system 200. Keyboard 214 is one exemplary input device that enables communication into system 200 through keyboard interface 214a. Of course other commonly available input devices may be incorporated such as, a touch screen, voice recognition, etc. Internal register blocks 236 and pulse width modulation (PWM) block 238 that function to provide audio power amplification, are additional modules within system 200. System 200 may communicate with a read-only memory (ROM)/flash memory 240. In addition, system 200 may communicate with a host central processing unit through host interface 242. Connected to bus 228 are serial flash interface 224, I2S module 222, Sprite engine 230, embedded CPU and coprocessors 232, bus bridges 212 and 234, and host interface 242. Bus 244 is in communication with keyboard interface 214a, PWM 238, internal register blocks 236, LCDC 206, heads up display module 102, camera 202, serial/interface 224 and I2S module 222. As mentioned above, HUD system 102 may include calibration module 103 or calibration module 103 may be a separate external module as illustrated in FIG. 2. In addition, HUD system 102 may incorporate a Dewarping module in one embodiment. In this embodiment, the Dewarping module may share the resources of HUD system 102, i.e., memory and processor resources. It should be noted that these resources may be shared with calibration module 103 when the calibration module is integrated in HUD system 102. In another embodiment, Dewarping module 105 is a stand-alone module that employs code/logic and obtains the calibration module 103 output to produces inputs, i.e., offsets, to the warp image circuitry. Thus, in this implementation de-warping module 105 runs “off line” and outside the warping circuitry on a personal computer, for example, such as the embodiment where calibration module 103 runs “of-line.” One skilled in the art will appreciate that system 200 may be in communication with a central processing unit through host interface 242. In addition, a portion of system 200, e.g., HUD system 102 and camera block 202 may be integrated into a liquid crystal display controller (LCDC), such as LCDC 206.

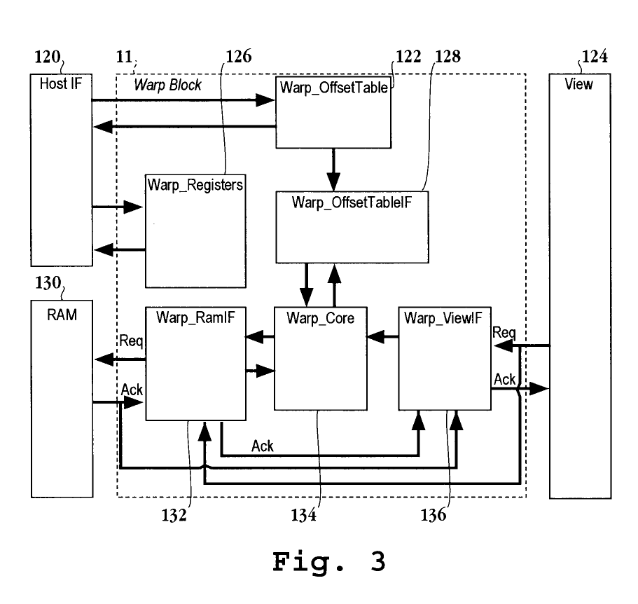

FIG. 3 is a simplified schematic diagram further illustrating the functional blocks of the warp image circuitry in accordance with one embodiment of the invention. Warp block 11 is in communication with host interface 120, random access memory (RAM) 130, and display panel 124. Within warp block 11 is warp offset table 122, which stores values representing the offsets for corresponding pixels to be displayed. Thus warp offset table 122 includes an arbiter and a memory region, e.g., RAM, for storing the offsets. It should be appreciated that warp offset table 122 contains relative values which may be though of as distances from a portion of corresponding pixel values of the image to be displayed. The portion of corresponding pixel values correspond to the vertices of the blocks in one embodiment. In an alternative embodiment, actual coordinates may be stored rather than the offsets. Warp register block 126 is included within warp block 11 and communicates with host interface 120. Warp register block 126 is a block of registers that sets the image size and/or the block size and initiates the bilinear interpolation in one embodiment. One skilled in the art will appreciate that the actual design may distribute registers throughout warp block 11, rather than as one block of registers. Warp offset table interface 128 communicates with warp offset table 122 and functions as the interface for warp offset table 122. Warp offset table interface 128 includes a counter and reads the offsets from warp offset table 122 according to the corresponding pixel location being tracked. For example, for each pixel position the counter may be incremented to track the position being displayed/operated on within the image being displayed as per the order of rendering. Warp core 134 is in communication with warp offset table 128, warp RAM interface 132, and warp view interface 136.

Warp core 134 of FIG. 3 is the main calculation block within the warp circuit. Thus, warp core 134 calculates coordinates from the values in the offset table according to the location within the image, as provided by warp offset table interface 128. In one embodiment, warp offset table interface 128 transmits requested data to warp core 134 upon a signal received from the warp core that the warp core is ready. Once warp core 134 reads the data and transmits an acknowledge signal back to warp offset table interface 128, the warp offset table interface 128 will begin to read a next set of offsets from warp offset table 122. Warp core 134 functions to map the image as a plurality of spaced-apart planar cells to coordinates of the non-planar surface, with each of the cells including multiple pixels of the image. The distance between the cells is minimized while minimizing a distance of each of the plurality of cells with respect to the surface coordinates and impinging the plurality of planar cells upon the non-planar surface as discussed in more detail in application Ser. No. 11/550,153 (Atty Docket No. VP248). As a brief overview of the functionality provided by warp circuit 11, and in particular warp core 134, the mapping of the image as a plurality of spaced apart cells includes associating pixels of the image with a plurality of polygons, each of which defines one of the plurality of spaced-apart cells and includes multiple vertices having an initial spatial relationship. The vertices, or corners, which correspond to the calibration points of the calibration image, are mapped to coordinates of the non-planar surface to produce mapped polygons. A matrix of distortion coefficients is generated from the vertices of the mapped polygons. The distortion coefficients define a relative spatial relationship among the pixels upon the non-planar surface. Produced from the distortion matrix is an inverse matrix having a plurality of inverting coefficients. The original image data is displayed as inverted polygons to negate distortions introduced when the image data is impinged off of a non-planar surface.

Still referring to FIG. 3, warp RAM interface 132 is in communication with RAM 130 and warp core 134. Additionally, warp RAM interface 132 communicates with warp view interface 136. Warp RAM interface 132 functions as an interface with external RAM 130. Warp RAM interface 132 will evaluate new coordinates derived from warp core 134 and if necessary, will read pixel data from random access memory 130. If a read from RAM 130 is unnecessary, e.g., the coordinate is outside of the image size, then warp RAM interface 132 communicates with warp view interface 136 to output background image to view block 124. In one embodiment, if bilinear interpolation is enabled, if the coordinate is not one of the vertices having offset data, then warp RAM interface 132 will read the necessary pixel data from RAM 130 as outlined in U.S. patent application Ser. No. ______ (Atty Docket VP251). For example, from a register setting provided by warp registers 126, warp core 134 determines whether to apply bilinear interpolation based on four coordinates in one embodiment. Warp RAM interface 132 reads the necessary data for this interpolation from RAM 130 and calculates a new pixel. Warp view interface 136 includes a first in first out (FIFO) buffer and functions to enable synchronous communication with outside blocks such as an interface for display panel 124. Thus, warp view interface 136 sends pixel data to an outside block with an acknowledge signal when warp view interface 136 is not empty.

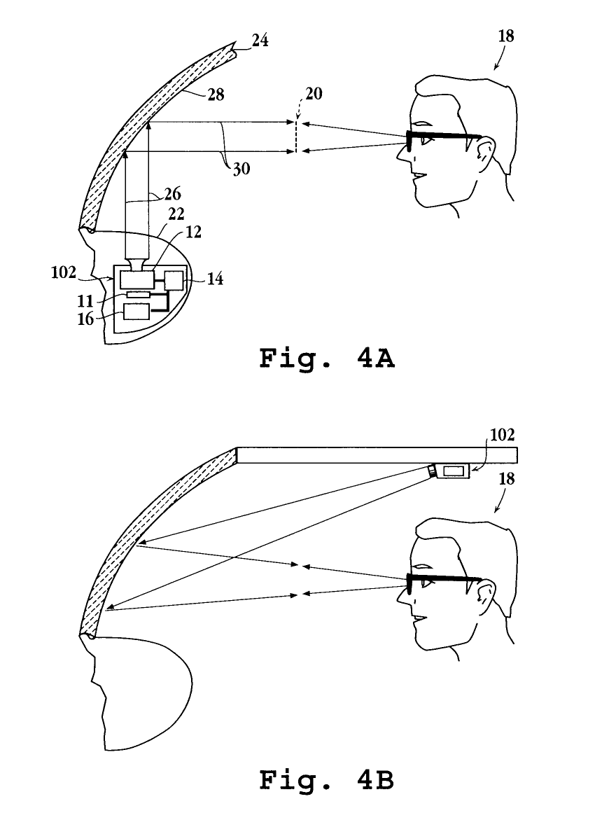

FIG. 4A is a simplified schematic diagram illustrating an exemplary application the heads up display system for a vehicle in accordance with one embodiment of the invention. Heads up display system 102 includes projector module 12, processor module 14, memory 16 and warp image circuitry 11. The projected image is directed to surface 24, which is a windshield of a vehicle in one embodiment. In this embodiment, viewer 18 will perceive the image impinged off of windshield 24 and as the image is inverted through the heads up display system, the viewer will perceive the image as being non-distorted.

FIG. 4B is a simplified schematic diagram illustrating an alternative embodiment to FIG. 4A. Here, viewer 18 perceives the image again being impinged off of surface 24. However, the heads up display system and projector are located above and/or behind the viewer's head. It should be appreciated that the actual circuitry for the heads up display system may be located separate from the projector in accordance with one embodiment of the invention. Alternatively, the projector may also project the image onto glasses being worn by a user so that a small section of the glasses will show the image being projected. It should be noted that in the embodiment depicted in FIG. 4A, the projector is located below a line of sight within the field of view of viewer 18. In FIG. 4B, the projector is located above a line of sight within the field of view of viewer 18. In addition, while the non-planar surface is illustrated as a wind shield, it will be apparent to one skilled in the art that alternative surfaces may be employed. In one embodiment, glasses worn by viewer 18 may be used as the non-planar surface. In this embodiment, the projector is located over the viewer's head and possibly offset from behind the viewer to access the lens of the eye glasses, as illustrated in FIG. 4B. Of course, the projector may be located between a driver and a passenger, or configured to direct the image to a location between the driver and the passenger, so that both the driver and passenger can see the resulting dewarped image.

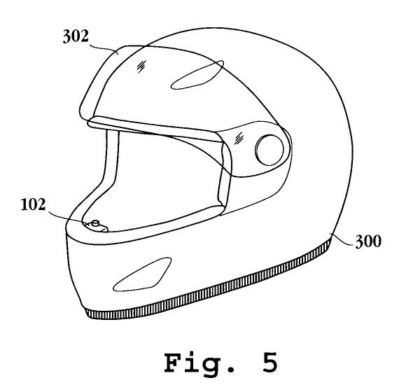

FIG. 5 is a simplified schematic diagram of an alternative embodiment for a heads up display system in accordance with one embodiment of the invention. Helmet 300 includes heads up display module 102. In this embodiment, an image is impinged off of helmet shield/visor 302 so that a user may view information about the vehicle in which the user is therein. Thus, the calibration image is captured for the interior surface of visor 302 of helmet 300. It should be appreciated that the calibration image is a separate image from the image data displayed by HUD module 102. In addition, once the data generated through the calibration technique is derived, there is no need to maintain the calibration image in one embodiment.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated. Further, the manipulations performed are often referred to in terms such as producing, identifying, determining, or comparing.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A vehicle having a heads up display (HUD) system, comprising:
an image rendering device configured to provide a distorted representation of image data to a non-planar surface within a field of view of an occupant of the vehicle; and
warp image circuitry configured to store offsets to be applied to the image data to generate the distorted representation provided to the image rendering device, the offsets representing respective distances for moving coordinates of a portion of pixels within the image data and stored within a memory region of the warp image circuitry, the portion of pixels corresponding to vertices of polygons, the offsets being derived through calibration data provided to the warp image circuitry, the calibration data being selected from one of a plurality of view positions for the occupant.

2. The vehicle of claim 1, wherein the non-planar surface is a windshield of the vehicle.

3. The vehicle of claim 1, wherein the image rendering device is located below a line of sight of the occupant.

4. The vehicle of claim 1, wherein the image rendering device is located above a line of sight of the occupant.

5. The vehicle of claim 1, wherein the image data displays data from an instrument panel of the vehicle.

6. The vehicle of claim 5, wherein the image data includes operating information unavailable on the instrument panel but tracked by the vehicle.

7. The vehicle of claim 1, wherein the vehicle is one of a land based vehicle, a water based vehicle, or an air based vehicle.

8. A heads up display (HUD), comprising:
a memory storing offsets to be applied to image data to generate a distorted representation of the image data;
warp image logic configured to map the image data to a non-planar surface and calculate an amount of distortion introduced into polygon sections of the image data on the non-planar surface, the warp image logic further configured to determine an inverse of the amount of distortion to be applied to the image data to attenuate the amount of distortion introduced by the non-planar surface; and
an image rendering device configured to direct the inverted and distorted representation of the image data to the non-planar surface.

9. The HUD of claim 8, further comprising:
an interface module enabling communication between the memory and the warp image logic, the interface module including a counter to determine one of whether to read offset data from the memory to calculate a pixel location or to interpolate the pixel location through the warp image logic.

10. The HUD of claim 8, further comprising:
a register block storing data providing an image size and a size associated with the polygon sections.

11. The HUD of claim 8, wherein the non-planar surface is a windshield of a vehicle.

12. The HUD of claim 8, wherein the non-planar surface is one of a visor of a helmet or a lens of a pair of glasses.

13. The HUD of claim 8, wherein the memory stores calibration data used to generate the offsets.

14. The HUD of claim 13, wherein multiple sets of calibration data is stored, each of the multiple sets of calibration data corresponding to a viewpoint within a device containing the HUD.

15. The HUD of claim 14, wherein the device containing the HUD is a vehicle.

16. A digitally based heads up display (HUD) system capable of presenting a non-distorted image off of a non-planar surface, comprising:
a calibration module configured to generate a set of inputs for a de-warping process;
warp image circuitry configured to execute the de-warping process, the warp image circuitry generating a set of offsets to be applied to a portion of image data, the offsets generated from the set of inputs of the calibration module, the warp image circuitry further configured to determine an amount of distortion experienced by the image data from the non-planar surface to generate an inverse of the amount of distortion and apply the inverse of the amount of distortion to the image data; and
an image rendering device receiving the image data having the inverse amount of distortion applied thereto, the image rendering device directing the image data having the inverse amount of distortion to the non-planar surface.

17. The digitally based HUD system of claim 16, wherein the warp image circuitry and the image rendering device are integrated into a vehicle and the calibration module is a detachable module that supplies the set of inputs and remains separate from the vehicle.

18. The digitally based HUD system of claim 16, wherein the calibration module generates a plurality of sets of inputs, each of the sets on inputs associated with a corresponding viewpoint through the non-planar surface.
